(19) United States
(12) Patent Application Publication
(10) Pub. No.: US 2022/0256815 A1
(43) Pub. Date: Aug. 18, 2022

(54) SYSTEM AND METHOD FOR FEED MIXTURE PREPARATION

(71) Applicant: AMBAR FEED MILLS ACS LTD., Granot (IL)

(72) Inventor: Nimrod Tsur, Givatayim (IL)

(21) Appl. No.: 17/623,032

(22) PCT Filed: Jul. 5, 2020
(86) PCT No.: PCT/IL2020/050751

§ 371 Date: Dec. 27, 2021

(30) Foreign Application Priority Data
Jul. 7, 2019 (IL) 267887

(51) Int. Cl. A01K 39/012; A01K 5/02

(52) U.S. Cl. CPC A01K 39/012; A01K 5/0275

(57) ABSTRACT

The present disclosure concerns a system and a method for the preparation of adaptive batch of feed mixture for an animal habitat. The system includes a mixing unit that is linked to storage containers, each storage container stores a different type of feed component that is suitable for different state of the animal. A controller of the system receives data indicative of the state of the animals in the habitat and facilitates a flow of desired amounts of each feed and/or supplements or immune additives into the mixing unit, based on data that is corresponding to the state of the animals. The feed components are mixed in the mixing unit to obtain a desired feed mixture and the mixing unit is configured to convey the feed mixture to a feeding line that further conveys the feed mixture to feeding ports, within the habitat.

### TECHNOLOGICAL FIELD

The present disclosure is in the field of industrial and commercial farming, in particular automated systems for animals rearing.

### BACKGROUND

Rearing animals for commercial needs includes feeding and treating groups of large numbers of animals. For example, a commercial poultry house may include ten thousand of poultries at a certain time. Typically, each commercial animal habitat includes animals of about the same age, e.g. a group of poultries that hatched on the same day. Since it is impossible to give a special treatment to each of the animals, they are treated as a group, and are given similar type of feed, similar supplements, drugs, etc. The type feed that is given to the animals is changed in several increments over the rearing period of the animals. In the case of poultries, an entire rearing period includes four different type of feeds—the first suitable for the first ten days, the second for the tenth day until the twentieth day, etc. Each type of feed includes an average of ingredients that the poultries need at the period of time of ten days.

Feeding the poultries on a daily basis the most accurate feed they need may increase the yield of the commercial rearing of poultries.

### GENERAL DESCRIPTION

The present disclosure concerns a system and a method for the preparation of a batch of adaptive feed mixture for an animal habitat, e.g. a commercial poultry house.

The system includes a mixing unit that is linked to storage containers, each storage container stores a different type of feed component that is suitable for different state of the animal, e.g. different age of the animals or different physical state or health condition of the animal. It should be noted that each feed component may be a mixture of ingredients that all together are referred to a feed component. Optionally, the mixing unit may be also linked to one or more auxiliary storage container that include an additive component such as feed supplements, medical treatment additives (e.g. drugs), pharmaceutical substances, immune additives, nutritious or any other edible supplements (all referred as “additives”). By mixing different amounts of each feed and/or additives, the most accurate feed and the additive requirements for each sub-period of the entire rearing period of the animals are met. Thus, for example, each day a different mixture is prepared that is suitable for the current state of the animals. It should be noted that the feed mixture may be adjusted at any desired frequency or even in a continuously manner. By providing a continuously adapting feed mixture to the animals, their growing rate increases and the rearing period may be shortened.

A controller of the system receives data that is indicative of the state of the animals in the habitat and facilitates a flow of desired amounts of each feed and/or supplements or immune additives into the mixing unit, based on the data that is corresponding to the state of the animals. The mixing unit mixes the components to obtain a desired feed mixture and is configured to convey the feed mixture to a feeding line that further conveys the feed mixture to its final destinated location, e.g. feeding ports in the habitat. It should be noted that the mixture within the mixing unit may reach a desired level of homogeneousness merely upon the dispensing of the feed components therein, namely it may be obtained passively without a specific mixing member, due to inertia of the feed components on their flow into the mixing unit. Furthermore, the homogeneousness of the mixture may also increase while being conveyed in the feeding line before reaching the feeding ports. However, in some embodiments, the mixing unit may include means for mixing the feed components to obtain a desired level of homogeneousness, such as agitation means, or mixing blades.

Therefore, a first aspect of the present disclosure provides a system for preparing a feed mixture for an animal habitat. The system includes a mixing unit configured to be coupled to at least two storage containers. Each of the storage containers comprises a different feed component such that different mixtures thereof span all the feeding requirements over the rearing period of the animals. The mixing unit is configured for receiving feed component from each storage container via a corresponding dispensing unit associated with each container. Namely, each storage container has a corresponding dispensing unit that controls the flow of the feed from each storage container into the mixing unit. The feed mixture is mixed within the mixing unit, passively or actively, to obtain a certain degree of homogeneousness of the feed mixture.

The system includes a controller that is configured to receive input data indicative of a state of the animals in the habitat and/or the state of the environmental conditions in their surrounding, and based thereon operate the dispensing unit of each container to dispense desired amounts of each feed component for obtaining the desired proportions of feeds for the feed mixture.

The mixing unit is further configured to be coupled to a feeding line for conveying the feed mixture thereto.

In some embodiments, the system comprises at least one of (i) the at least two storage containers; and (ii) the feeding line that is coupled to the mixing unit and configured to convey the feed mixture to feeding ports of the animal habitat.

In some embodiments of the system, the dispensing units are directly coupled to the mixing unit. The dispensing units may be in the form of selective ports that are formed at the entrance to the mixing unit, which selectively allow feed from each corresponding storage container to flow into the mixing unit. For example, a port may receive a first signal to allow the flow into the mixing unit and receive a second signal to seize the flow. Furthermore, these selective ports may be configured to change the dispensing rate, namely the amount of feed that is dispensed in a certain amount of time into the mixing unit. The controller of the system calculates the total amount of feed that is dispensed to the mixing unit of each feed and control the dispensing rate to meet the requirements of each feed to the mixture. When the requirement is met, the controller is configured to stop the dispensing of the respective feed.

In some embodiments of the system, the data of the state of the animals comprises or indicative of at least one of the following parameters: average age of the animals, average weight of the animals, level of movement of the animals, health condition of the animals, feed consumption rate, liquid/water consumption rate, the level of stress of the animals or any combination thereof.

Due to the large numbers of animals in the habitat, the parameters of the animals are averaged to facilitate the collective treatment conditions of the habitat. For example, the feed mixture that is prepared for a certain age is determined based on an average age of the animals that are expected to receive the batch of the feed mixture. Typically, the animals are grouped in the habitat based on their age, e.g. poultries that hatched on the same day are grouped in a single poultry house.

In some embodiments of the system, the input data further comprises data indicative of environmental conditions within or in the surrounding of the animal habitat, such as temperature, humidity, gases concentrations (e.g. ammonia), precipitation, etc. The data of the environmental conditions may be derived from sensors that are located within and at the vicinity of the habitat or from external data providers, such as APIs. For example, the data can be derived from temperature sensor, humidity sensor, gas analyzer, weather forecast API, etc.

In some embodiments of the system, the mixing unit is configured to be coupled to an auxiliary container, e.g. an auxiliary silo, associated with an auxiliary dispensing unit for receiving at least one of the following auxiliary components: feed supplements, medical treatment additives, pharmaceutical substances, nutritious or any other edible supplements.

The controller is configured to operate the auxiliary dispensing unit to dispense a desired amount of an auxiliary component based on the input data that may include data that is indicative of physical conditions of the animals in the habitat. For example, in the instance that a disease is spread in the habitat, the controller may operate the auxiliary dispensing unit to dispense additives for treating the disease in the habitat.

In some embodiments, the at least two storage containers are in the form of silos. The silos are filled with a feed component to provide the demand for the preparation of the feed mixture for each batch.

In some embodiments, each of the feed components comprises a mixture of feed ingredients, such as a plurality of different types of grains. In other words, each feed may be a mixture of feed components that constitute the stored feed.

In some embodiments of the system, the controller is configured to receive periodically or continuously updated input data. The input data may be transmitted to the controller on-demand, namely the controller may be configured to determine the input data at a desired rate, according to user's requirements. In some embodiments, the controller receives initial input data and is configured to determine a mixing plan, for the entire rearing period, based on the initial input data.

In some embodiments of the system, the input data is updated daily, namely the controller retrieve the input data once a day and update the mixture proportions accordingly. In some embodiments, the input data may be updated based on any desired frequency, e.g. hourly or every certain fraction of an hour, or even updated continuously. According to some embodiments, the user, e.g. a farmer, may adjust the frequency according to its needs.

In some embodiments, the system comprising a user interface that is configured to control parameters of the controller, such as sampling rate of the input data, manually selecting a mixing plan to obtain specific mixtures, inputting data (e.g. the average age of the animals). The user interface may be a part of the system at the site of the mixing unit or it can be at a remote location, e.g. an API on a mobile device that remotely communicating with the system in the site.

In some embodiments of the system, the controller is configured to dispense a desired amount of at least one of the feed components proportionally or reverse-proportionally to at least one of the following: average age of the animals and average weight of the animals. In other words, the controller stores in its memory mixing plans that include decreasing or increasing proportions of at least one feed components as the average age or the average weight of the animals rises.

In some embodiments of the system, the animal habitat is a commercial poultry house, e.g. a poultry house. It should be noted that the system may also be applied on pen, cowshed and other animal habitats.

In some embodiments of the system, the controller is configured to select one predetermined mixing plan, out of a plurality of mixing plans, according to the input data, and operate the dispensing units based on the selected mixing plan.

In yet another aspect of the present disclosure provides a system for preparing a feed mixture for an animal habitat. The system comprises a mixing unit that is coupled to at least two storage containers for receiving feed component from each container via a corresponding dispensing unit of each container. Each of the at least two storage containers comprises a different feed component.

The feed mixture is mixed within the mixing unit, passively or actively by a mixing element, to obtain a certain degree of homogeneousness of the feed mixture.

The system further comprises a controller configured to receive input data indicative of a state of animals in the habitat, and operate the dispensing unit of each container based on the input data, to dispense desired amounts of each feed component for obtaining the feed mixture.

The system comprises a feeding line coupled to the mixing unit for conveying the feed mixture thereto. The feeding line is configured to convey the feeding mixture to feeding ports in the habitat.

Another aspect of the present disclosure provides a method for preparing a feed mixture for an animal habitat. The method includes (i) receiving input data indicative of a state of animals in the animal habitat; (ii) selecting a mixing plan based on the input data; (iii) dispensing desired amounts of the at least two feed components into a mixing unit based on the input data; and (iv) mixing the feed components to obtain homogenous feed mixture. Each of the feed components is separately stored and is dispensed independently of the other feed components.

In some embodiments, the method further comprising conveying the feed mixture to animal feeding ports in the animal habitat.

In some embodiments of the method, each of the feed components comprises a mixture of feed ingredients, e.g. a plurality of different type of grains, fibers, vegetables, meal (e.g. soybean meal, sunflower meal), vitamins, minerals, etc.

In some embodiments, the state of the animals comprises at least one of the following parameters: average age of the animals, average weight of the animals, level of movement of the animals, feed consumption rate, liquid/water consumption rate, the level of stress of the animal or any combination thereof.

In some embodiments of the method, the input data further comprises data indicative of environmental conditions within or in the surrounding of the animal habitat, e.g. temperature, humidity, gases concentrations (e.g. ammonia), precipitation, etc.

In some embodiments of the method, the input data is periodically or continuously updated and received to update a mixing plan.

In some embodiments of the method, the mixing plan is re-selected upon update of the input data, e.g. on a daily basis.

In some embodiments of the method, the animal habitat is a commercial poultry house, e.g. a poultry house.

In some embodiments of the method, the desired amount of at least one feed component is proportional or reverse-proportional to at least one of the following: average age of the animals and average weight of the animals.

In some embodiments of the method, the mixing plan is selected out of a plurality of mixing plans. In some embodiments, the mixing plan for the entire rearing period is selected based on initial input data.

In some embodiments of the method, the mixing plan is pre-set, namely the mixing plan is stored in a memory and is selected upon satisfying a certain condition based on the input data.

In some embodiments, the method is carried out automatically, namely without intervention of a user. It is to be noted that the method is considered to be automatic even in the instance that a user entered an initial input data, such as a hatching date of a group of animals.

In some embodiments, the method further includes mixing desired amounts of auxiliary component, separately stored from the at least two feed components, based on the selected mixing plan. The auxiliary component is selected from at least one of a plurality of additives, such as feed supplements, medical treatment additives, pharmaceutical substances and nutritious.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1C are block diagrams of non-limiting examples of embodiments of the system according of the present disclosure.

FIG. 2 is a schematic illustration of non-limiting example of the system according to an embodiment of the present disclosure.

FIG. 3 is a flow diagram of a non-limiting example of an embodiment of a method for preparing a feed mixture according to the present disclosure.

FIG. 4 is a graph showing the actual lysine amino acid requirements in a rearing period of a poultry (solid line) versus lysine supply in a 3-batches feeding regime according to the common practice (dashed line).

### DETAILED DESCRIPTION OF EMBODIMENTS

The following figures are provided to exemplify embodiments and realization of the invention of the present disclosure and it is to be understood that the invention of the present disclosure in not limited to any of the specific configurations of these examples.

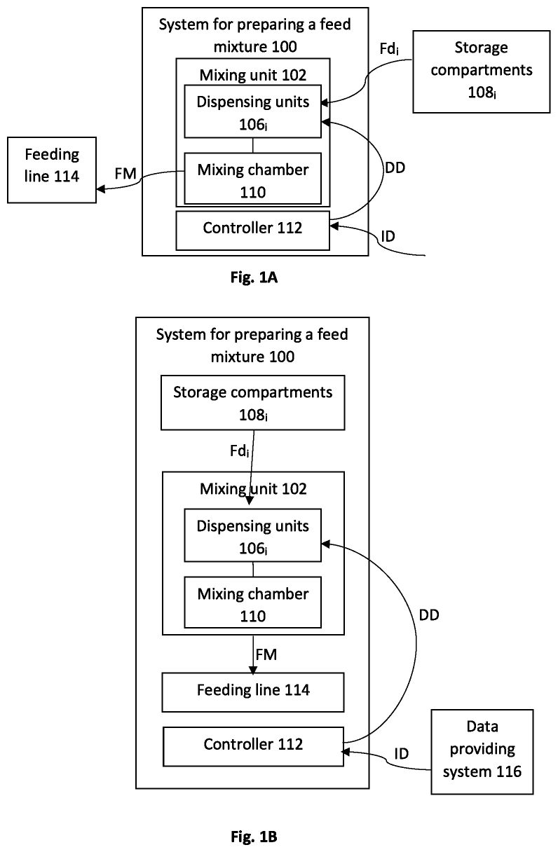

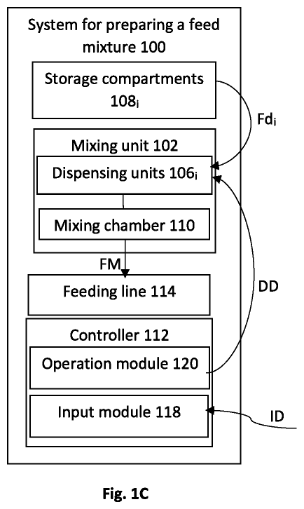

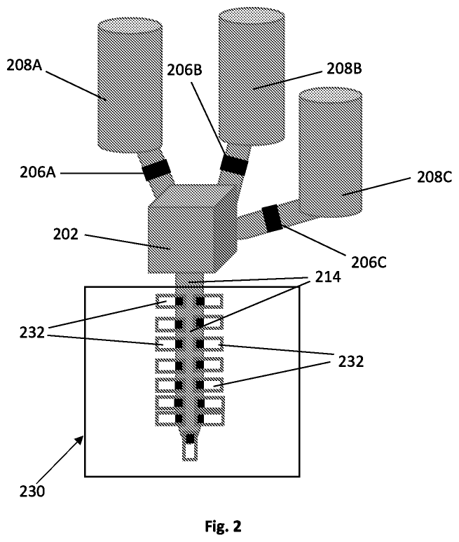

Reference is first made to FIGS. 1A-1C, which are block diagrams exemplifying embodiments of a system for preparing a feed mixture for an animal habitat, e.g. a commercial poultry house, according to the present disclosure.

FIG. 1A exemplifies a system 100 that includes a mixing unit 102 and a controller 104. It is to be noted that a controller refers to a processing circuitry that is configured to perform processing of data and generate execution data to be executed by physical elements of the system. The controller may be a single component or several distributed components, all referred together as a controller. The mixing unit 102 includes dispensing units 106ᵢ, (where ‘i’ is a dispensing unit number i=1, 2, 3, 4, 5, 6 . . . ) each is linked to storage containers 108ᵢ (where ‘i’ is a storage container number i=1, 2, 3, 4, 5, 6 . . . ) and is configured to receive feed Fdᵢ from a corresponding storage container 108ᵢ. The dispensing units 106ᵢ regulate the flow of feeds from each container to a mixing chamber 110. The regulation of the flow is carried out according to a demand and is performed by an automatic controller as elaborated below. The mixing chamber 110 of the mixing unit 102 is configured to receive the feeds Fdᵢ via the dispensing units 106ᵢ and to mix them to obtain a feed mixture FM. The mixing may be obtained passively, namely by the flow of the feed into the mixing unit through the dispensing units, or carried out by agitation of the mixing chamber and/or by mixing elements within the mixing chamber 110. The feed mixture that is obtained following the mixing within the mixing chamber 110 is typically homogeneous or partially homogeneous, namely the plurality of feeds that constitute the feed mixture are homogeneously or partially homogenously spread in the mixture. It should be noted that the homogeneousness of the mixture may increase while the mixture is further conveyed to the feeding ports.

The amount of feed Fdᵢ that is dispensed from each storage container 108ᵢ to the mixing chamber 110 is controlled by a controller 112. The controller is configured to receive an input data ID and generate dispensing data DD based thereon. The dispensing data DD is indicative of the desired amount of each feed Fdᵢ, e.g. a desired amount of volume or weight, in a final feeding mixture FM product. The controller controls the dispensing units based on the dispensing data DD to dispense the desired amount of feed Fdᵢ from each container to the mixing chamber, to obtain the desired feed mixture FM.

The input data ID may include various data pieces that affect the resulting final feed mixture product. A first data piece is the average age of the animals of the habitat, e.g. days from hatching for poultries, or days from being born for mammals. It is to be noted that by referring to the animals in the habitat, it is referred to the animals in the habitat that are expected to receive the final feed mixture product of a single batch of the feed mixture. An animal habitat may include several groups of animals, each is expected to receive its own feed mixture according to the characteristic parameters thereof, e.g. its own specific average age. For example, in the instance using two storage containers that stores two different feeds, a first feed that fits for early age animals, constitutes the entire feed mixture of the first day of rearing of the animals, and a second feed that fits for advanced ages of the animals, constitutes the entire feed mixture in the last day of rearing of the animals in the animal habitat. In between the first and last day of rearing, the proportion of the first feed in the mixture decreases over time and the proportion of the second feed increases over time.

The input data ID may further include data indicative of at least one of: (i) movement profile of the animals of the habitat, which is obtained by movement sensors within the habitat and may be indicative of the state of the animals, namely whether they are in stress; (ii) environmental conditions within the animal habitat or in the surrounding thereof, for example, extreme weather conditions, such as extreme heat or cold; and (iii) immune profile of the animals, obtained by routine tests in the habitat, namely whether they need to receive any supplements to provoke immune response, or whether there is a disease that needs to be treated. This data can be input automatically or manually into the controller. There may be a specific container that includes supplements and/or immune additives (e.g. drugs) that are mixed in the feed mixture by demand, according to a specific input.

Therefore, the controller 112 is configured to receive all the above input data ID and control the dispensing units 106ᵢ accordingly to obtain a desired feed mixture FM that may include feed supplements or immune additives.

The input data ID may be received by a user that enters the data via a user interface. Alternatively, the input data ID may be retrieved automatically. For example, the controller 112 may be in data communication with an external system and continuously or periodically fed thereby with data that constitutes the input data or part thereof. The external system may be configured to collect data related to the age of the animals, the environmental conditions and the state of the animals and communicate it to the controller 112.

The controller 112 may monitor the mixing process by receiving data indicative of storing quantities of feeds in each storage compartment 108ᵢ, e.g. data obtained by weight sensors. The controller 112 predicts the amount of feed that is expected to remain in each storage compartment 108ᵢ at any time and upon receiving measurements of the quantities of the feed that is found in each storage compartment 108ᵢ, the controller 112 compares the current levels/quantities of feed with the expected prediction and determines whether there is a deviation. If the controller 112 identifies a deviation from the expected quantities, it outputs an alert. Such an alert may be presented to the user via various options, for example via a user interface on a mobile device. The process monitoring described above may be carried out in real-time, namely all the data is measured, transmitted, and processed in a continuous or semi-continuous manner.

The mixing unit 102 is further configured to convey the feed mixture FM to a feeding line 114 that comprises a plurality of feeding ports for feeding the animals within the habitat.

FIG. 1B exemplifies an embodiment of the system 100 that includes the storage containers 108ᵢ and the feeding line 114 as part of the system. Furthermore, it is exemplified that the controller is configured to receive the input data ID from a data providing system 116. The data providing system 116 is configured to collect the relevant data and generate the input data ID that is continuously or periodically transmitted to the controller 112.

FIG. 1C exemplifies another embodiment of the system of the present disclosure. Specifically, FIG. 1C shows the modules of the controller, including an input module 118 and an operation module 120. The input module 118 is configured to receive the input data ID and the operation module 120 is configured to generate the dispensing data DD based thereon and operate the dispensing units 106ᵢ according the dispensing data DD.

It should be noted that the examples of FIGS. 1A-1C focus on selected elements of the system while generally describe various configurations of the feed preparation system. Generally, system elements from FIGS. 1A-1C may be combined between them to provide the feed preparation system of the present invention.

In the figures throughout the application, like elements of different figures were given similar reference numerals shifted by the number of hundreds corresponding to the number of the figures. For example, element 102 in FIG. 2 serves the same function as element 102 in FIGS. 1A-1C.

FIG. 2 is a schematic illustration of a non-limiting example of the system according to the present disclosure. The system 200 includes a first and second storage containers. In this example, the first and second storage compartments are in the form of silos 208A and 208B, respectively. Each of the storage containers stores a different type of feed such that different proportions of the two feeds provides a plurality of feed mixtures that are suitable for the entire rearing period of animals in the animal habitat 230.

An auxiliary silo 208C stores feed supplements and/or immune stimulating additives that may be mixed in the feed mixture together with the feeds of silos 208A and 208B. The silos 208A, 208B and 208C are linked to a mixing unit 202 via corresponding dispensing units 206A, 206B and 206C. A controller (not shown) is configured to operate the dispensing units such that each dispenses a desired amount of feed and/or supplements to the mixing unit 202. The mixing unit 202 receives the desired amounts of feeds and/or supplements from the silos according to the operation of the dispensing units by the controller such that the feeds are mixed therein to obtain a desired homogenous feed mixture. The controller operates the dispensing unit based on input data that is at least indicative of the average age of the animals in the habitat that receives the feed mixture.

It is to be noted that the animal habitat may include various sections, each with different requirements of feed mixtures. For each section, a different feed mixture is prepared according to the input data that is relevant thereto. Thus, several batches of feed mixture may be prepared for a single animal habitat, each of the batches may be constituted by different proportions of feeds.

A conveying feeding line 214 links the mixing unit 202 to feeding ports 232 in the animal habitat 230. The mixing unit 202 is configured to convey the feed mixture to the conveying feeding line 214 such that portions of the feed mixture reaches the plurality of feeding ports 232 so as to feed the animals in the animal habitat 230.

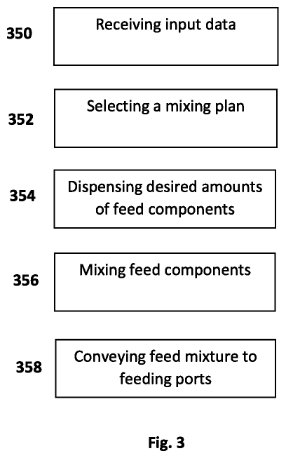

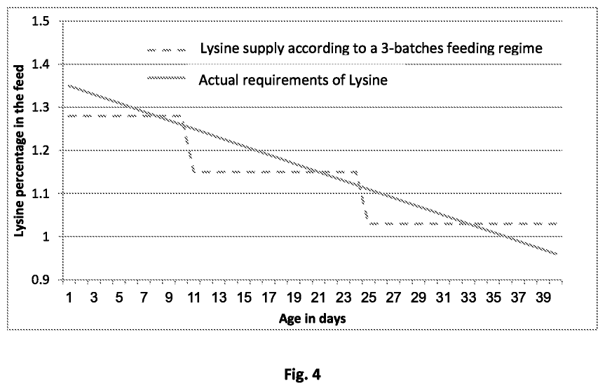

FIG. 3 is a flow diagram exemplifying an embodiment of a method for preparing a feed mixture for an animal habitat according to the present disclosure. The method includes receiving input data 350 that is indicative of the state of the animals in the habitat. The state of the animals in the habitat may include at least one of the following parameters: an average age, an average weight, and/or an average level of movement of the animals, feed consumption, water consumption or any combination thereof. Based on the input data, the method includes selecting a mixing plan 352 of pre-stored feeds. The mixing plan includes the proportions of each feed, namely the amount of each feed out of the final feed mixture product. The mixing plan may include also an amount of supplements or immune additives according to a demand based on the input data. Then, the method follows with dispensing desired amounts of feed components 354 into a mixing chamber and mixing the feed components 356 to obtain the desired feed mixture with a desired homogeneity. It is to be noted that each of the original pre-stored feeds that constitute the final feed mixture product may include various ingredients, such as various types of grains.

The above method may be followed by conveying the feed mixture to feeding ports 358 within the animals' habitat that are accessible to at least one group of animals therein. By this method, a group of animals in the habitat receives feed mixture that is specifically suitable for the conditions of the animals of the group, namely each group of animals in the habitat, given that it is separated from other groups in the habitat, may receive its own specific feed mixture in its own, dedicated, feeding ports.

FIG. 4 is a graph showing the actual lysine amino acid requirements in a rearing period of a poultry (solid line) versus lysine supply in a 3-batches feeding regime according to the common practice (dashed line). As can be appreciated, the requirements of lysine during the rearing period of poultries are continuously changing through the days. In the batches regime, the actual requirement of lysine by the poultry is adequately met only at very specific points during the rearing period (5 times in this specific example). At most of the time, the poultries are fed with a deficiency or excess of lysine, which can negatively affect their rearing process. As opposed to that, the exact amount of lysine that is required for the poultries at any time can be supplied by the system and method of the present disclosure. Furthermore, in the instance that a deviation from the rearing progress is observed, e.g. the average weight of poultry in the habitat is lower than expected, a user can instruct the system to add a specific ingredient or to mix more or less from a feed component to obtain the desired feed mixture.

1-30. (canceled)

31. A system for preparing a feed mixture for an animal habitat, the system comprising:
a mixing unit configured to be coupled to at least two storage containers, each of the at least two storage containers comprising a different feed component, and for receiving feed component from each of the at least two containers via a corresponding dispensing unit of each of the at least two containers;
a controller configured to receive input data indicative of a state of animals in the animal habitat, and operate the dispensing unit of each of the at least two containers based on the input data, to dispense desired amounts of each of the different feed components for obtaining the feed mixture; and
wherein the mixing unit is configured to be coupled to a feeding line for conveying the mixture thereto.

32. The system of claim 31, further comprising the at least two storage containers.

33. The system of claim 32, wherein the dispensing units are directly coupled to the mixing unit.

34. The system of claim 31, further comprising a feeding line coupled to the mixing unit and configured to convey the feed mixture to feeding ports of the animal habitat.

35. The system of claim 31, wherein the state of the animals comprises at least one of the following parameters: average age of the animals, average weight of the animals, feed consumption, water consumption, or level of stress of the animals.

36. The system of claim 31, wherein the input data further comprises data indicative of environmental conditions within or in the surrounding of the animal habitat.

37. The system of claim 31, wherein the mixing unit is configured to be coupled to an auxiliary silo having an auxiliary dispensing unit for receiving at least one of the following auxiliary component: feed supplements, medical treatment additives, pharmaceutical substances, or nutritious, wherein the controller is configured to operate the auxiliary dispensing unit to dispense a desired amount of an auxiliary component based on the input data.

38. The system of claim 31, wherein the controller is configured to dispense a desired amount of at least one of the feed components proportionally or reverse-proportionally to at least one of the following: average age of the animals or average weight of the animals.

39. The system of claim 31, wherein the animal habitat is a commercial poultry house.

40. The system of claim 31, wherein the controller is configured to select one predetermined mixing plan, out of a plurality of mixing plans, according to the input data and operate the dispensing unit based on the selected mixing plan.

41. A system for preparing a feed mixture for an animal habitat, the system comprising:
a mixing unit coupled to at least two storage containers, each of the at least two storage containers comprising a different feed component, and for receiving feed component from each container via a corresponding dispensing unit of each of the at least two containers;
a controller configured to receive input data indicative of a state of animals in the habitat, and operate the dispensing unit of each of the at least two containers based on the input data, to dispense desired amounts of each of the different feed components for obtaining the feed mixture; and
a feeding line coupled to the mixing unit for conveying the mixture thereto.

42. A method for preparing a feed mixture for an animal habitat, the method comprising:
receiving input data indicative of a state of animals in the animal habitat;
selecting a mixing plan based on the input data; and
mixing desired amounts of each of at least two feed components based on the selected mixing plan to obtain homogenous feed mixture, wherein each of the at least two feed components is separately stored.

43. The method of claim 42, further comprising conveying the feed mixture to animal feeding ports.

44. The method of claim 42, wherein each of the at least two feed components comprises a mixture of feed ingredients.

45. The method of claim 42, wherein the state of the animals comprises at least one of the following parameters: average age of the animals, average weight of the animals, feed consumption, water consumption, level of stress of the animals, or level of stress of the animal.

46. The method of claim 42, wherein the input data further comprises data indicative of environmental conditions within or in the surrounding of the animal habitat.

47. The method of claim 42, wherein the desired amount of at least one feed component is proportionally or reverse-proportionally to at least one of the following: average age of the animals or average weight of the animals.

48. The method of claim 42, wherein the mixing plan is selected out of a plurality of mixing plans.

49. The method of claim 42, wherein the method is carried out automatically.

50. The method of claim 42, further comprising mixing desired amounts of auxiliary component, separately stored from the at least two feed components, based on the selected mixing plan, wherein the auxiliary component is selected from at least one of the following: feed supplements, medical treatment additives, pharmaceutical substances, or nutritious.
